(19) United States
(12) Patent Application Publication
(10) Pub. No.: US 2018/0213725 A1
(43) Pub. Date: Aug. 2, 2018

(54) DUAL LAYER PLANTER LINER AND METHOD FOR MAKING SAME

(71) Applicant: Panacea Products Corporation, Columbus, OH (US)

(72) Inventor: Dwayne Williams, Columbus, OH (US)

(73) Assignee: Panacea Products Corporation, Columbus, OH (US)

(21) Appl. No.: 15/882,538

(22) Filed: Jan. 29, 2018

Related U.S. Application Data
(60) Provisional application No. 62/452,074, filed on Jan. 30, 2017.

(51) Int. Cl. A01G 9/02; B32B 1/02; B32B 5/02; B32B 5/26; B32B 7/12; B32B 37/12; B32B 37/18; B32B 38/00; B32B 38/18; B27N 5/00; B27N 1/02

(52) U.S. Cl. CPC A01G 9/02; B32B 1/02; B32B 5/02; B32B 5/26; B32B 7/12; B32B 37/1284; A47G 7/047; B32B 38/0004; B32B 38/164; B32B 38/1866; B27N 5/00; B27N 1/02; B32B 37/18

(57) ABSTRACT

The present invention provides a dual layer planter liner having: (a) a first fibrous layer having an interior surface and an exterior surface, the first fibrous layer is formed into a pot for emplacing a planting medium and/or plant therein. The first fibrous layer is formed from a first fibrous material; and a second fibrous material adhered onto the exterior surface of the first fibrous layer. The adhered second fibrous material forms a second fibrous layer. The present invention, also, provides a method for making the dual layer planter liner hereof.

### CROSS REFERENCE TO RELATED APPLICATION

This application is a completion application of co-pending U.S. Provisional Patent Application Ser. No. 62/452,074, filed Jan. 30, 2017, for “Coco Fiber Planter Liner and Method for Making Same”, the entire disclosure of which is hereby incorporated by reference, including the drawing.

### BACKGROUND OF THE INVENTION

### 1. Field of the Invention

The present invention pertains to horticultural-type planters. More particularly, the present invention concerns planter liners. Even more particularly, the present invention pertains to coconut fiber-based planters.

### 2. Description of Related Art

Horticultural-type planters have been utilized by home gardeners, horticultural professionals, and enthusiasts for growing a variety of plants. These planters may either be planted in the ground, situated on a table or other surface, or be displayed in a hanging flower “basket” or other container in which the planter is emplaced.

Ground implanted planters are primarily used to facilitate the transportation of plants or planting media disposed therein between different locations. These planters are formed from a biodegradable material and eventually break down leaving any implanted plants or flora rooted in the ground.

Hanging planters provide greater airflow through the planter than when located at a lower elevation such as sitting atop a table or buried in the ground. Increasing the amount of airflow improves the growing conditions within the planter.

Hanging planters typically include a metal, plastic, ceramic, or otherwise rigid container which forms an open geometric structure. To facilitate the most efficient amount of airflow through the container, the container may be an open network such as a wire-like structure or basket. Oftentimes, the container is a semi-circular or rectangular structure having a liner disposed therein. Preferably, the liner comprises any suitable material that permits airflow such as coconut fiber, sphagnum moss, paper/pulp mache, sisal or similar grass, or the like.

In addition to airflow, it is desirable in these horticultural applications that the planter retain an adequate amount of water while avoiding excess evaporation due to an overabundance of airflow through the liner. Therefore, the planter must be able to hold a sufficient amount of water while also being porous enough to facilitate the necessary airflow.

Coconut fiber, also referred to as “coco fiber” or “coir,” is a natural fiber made from the husk of ripe coconuts. While coconut fiber is commonly used in products such as floor mats and brushes, it can also be used in forming a planter liner due to its porous nature. Furthermore, coconut fiber is a neutral pH material and contains small amounts of beneficial phosphorus, potassium, and, oftentimes, exhibits antifungal properties as well. When soil or other growing medium is placed within the liner for supporting the roots of the growing plants planted therein, these beneficial properties aid in preventing disease in those plants.

As coconut fiber planter liners may be found to be too porous at times, the prior art has addressed this situation by proposing a number of planters and planter liners including a coconut fiber liner while minimizing the disadvantages of their porous nature.

For example, U.S. Pat. No. 6,789,355 to Rajagopalan, which issued Sep. 14, 2004, teaches a planter liner comprising an inner fibrous layer, an outer fibrous layer, and a plastic water tray disposed therebetween. The water tray extends from a bottom surface of the liner to a peripheral top edge. Thus, when water is poured into the liner, any excess water that accumulates above the peripheral edge of the water tray flows out of the planter liner through the outer layer of the liner. Thus, the water tray maintains a specific level of water within the liner while allowing any excess water to flow out of the liner.

Further, U.S. Pat. No. 7,685,770 to Van de Wetering et al., which issued Mar. 30, 2010, teaches a biodegradable planter comprising a specific blend of straw and coconut fiber. Initially, the blend is pressed and formed into a sheet. Thereafter, the sheet and, preferably, the outside surface of the sheet, is sprayed with a latex coating. The latex is cured by passing the sheet through a dryer and the sheet is then formed into a biodegradable planter by being placed over a mold. Curing the latex binds the straw and the coconut fiber together in order to increase the planter's structural integrity and ability to retain water.

Nonetheless, the water tray in Rajagopalan and the latex coating in Van de Wetering et al. clearly reduce the ability of air passing through the liner without providing any additional properties in exchange.

The planter liner and the planter disclosed in the above references, respectively, are suitable for the uses and problems they intend to solve. However, there is an ongoing need for improvements in a planter liner, such as one that maintains an appropriate amount of water within the liner without forfeiting its ability to permit airflow therethrough.

It is to this to which the present invention is directed.

### SUMMARY OF THE INVENTION

In a first aspect, the present invention provides a dual layer planter liner comprising: (a) a first fibrous layer having an interior surface and an exterior surface, the first fibrous layer formed into a pot for emplacing a planting medium and/or plant therein, the first fibrous layer formed from a first fibrous material; and (b) a second fibrous material adhered onto the exterior surface of the first fibrous layer, the adhered second fibrous material forming a second fibrous layer.

Adhering the second fibrous material onto the exterior surface of the first fibrous layer provides a planter liner with improved absorption capabilities while still allowing for a sufficient amount of airflow to pass therethrough.

In a second aspect hereof, the present invention provides a method for making a dual layer planter liner. The method comprises the steps of: (a) providing a first fibrous material; (b) spraying each side of the first fibrous material with a minimal airflow restrictive adhesive or latex; (c) drying the first fibrous material; (d) feeding the first fibrous material through a roller to provide a first fibrous sheet; (e) cutting the first fibrous sheet into predetermined sizes of smaller first fibrous sheets; (f) placing one of the smaller first fibrous sheets over a mold; (g) applying pressure to the smaller first fibrous sheet to provide a first fibrous layer conforming to the shape of the mold, the molded first fibrous layer having an interior surface and an exterior surface; (g) providing a second fibrous material; and (i) manually adhering the second fibrous material onto the exterior surface of the molded first fibrous layer, the adhered second fibrous material forming a second fibrous layer.

The second fibrous material may be provided in the form of a sheet such that at least a portion of the sheet is wrapped around the exterior surface of the first fibrous layer. Alternatively, the second fibrous material may be provided in smaller amounts of individual sections or pieces and separately adhered to specific areas of the exterior surface of the first fibrous layer.

In adhering the second fibrous material onto the exterior surface of the first fibrous layer, a minimal amount of an adhesive may first be applied directly onto the exterior surface of the first fibrous layer. Thereafter, the second fibrous material is deposited and adhered thereonto. Alternatively, the second fibrous material may be admixed with an adhesive. Then, the admixed second fibrous material is applied directly onto the exterior surface of the first fibrous layer.

For a better understanding of the present invention, reference is made to the accompanying drawing and detailed description. In the drawing, like reference numerals refer to like parts through the several views, in which:

### BRIEF DESCRIPTION OF THE DRAWING

FIG. 1 is a perspective view of a planter liner in accordance with the present invention emplaced within a hanging container;

FIG. 2 is a top view of the planter liner hereof; and

FIG. 3 is a block diagram showing a method for making a planter liner in accordance with the present invention.

### DETAILED DESCRIPTION OF THE INVENTION

As used herein, it is to be understood that the term “fibrous material” may include either natural or synthetic materials such as coconut fiber, sphagnum or peat moss, Spanish moss, paper/pulp mache, sisal or similar grass, wood bark, foliage, wool, woven textiles, or the like.

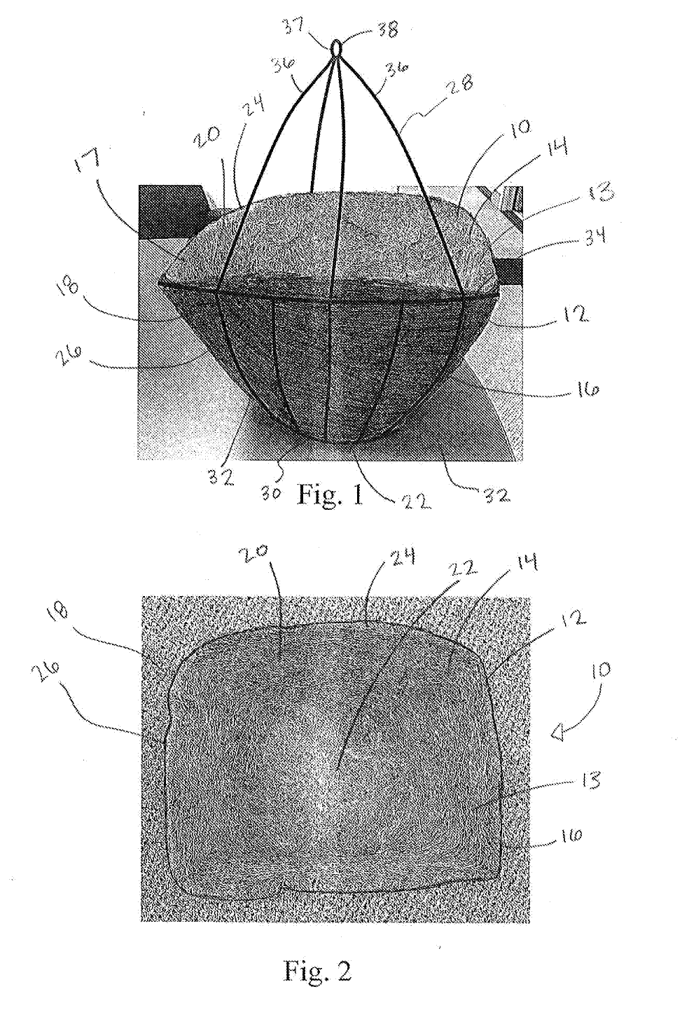

Now, in accordance with a first aspect of the present invention and with reference to FIGS. 1 and 2 of the drawing, there is shown a planter liner, generally, denoted at 10. The liner 10, generally, comprises: (a) a first fibrous layer 12 having an interior surface 14 and an exterior surface 16, the first fibrous layer 12 formed from a first fibrous material 13; and (b) a second fibrous material 18 adhered onto the exterior surface 16 of the first fibrous layer 12, the second fibrous material 18 forming a second fibrous layer 26.

Preferably, the first fibrous material 13 is coconut fiber. Coconut fiber is preferred due to its durable structure, especially when coated with an adhesive. Therefore, the first fibrous layer 12 and the first fibrous material 13 will be referred to as a coconut fiber layer 12 and coconut fiber 13, respectively, throughout the ensuing description.

Coconut fiber planter liners are well-known and commercially available such as those sold by Panacea Products. These coconut fiber liners are sold in a wide variety of geometries, but, generally, form a semi-circular or rectangular bowl ideal for placing soil and plants therein.

Here, the coconut fiber material 13 is formed into a coconut fiber layer 12 in the shape of a semi-circular bowl or pot 17 using a mechanical press in the manner described in detail below. The coconut fiber layer 12 includes a bottom wall or surface 22 and an integral arcuate wall 20 extending radially upwardly from the bottom surface 22 and terminating at a perimetral top edge 24. The coconut fiber layer 12 includes an interior surface 14 and an exterior surface 16.

The coconut fiber layer 12 is sufficiently fibrous and porous to ensure a balance between allowing adequate airflow therethrough while absorbing a suitable amount of water.

As noted above, coconut fiber is usually overly porous and, thus, water is not absorbed as much as desired to create an optimal growing environment. Therefore, the present invention further comprises a second fibrous material 18 deposited and adhered onto the exterior surface 16 of the coconut fiber layer 12, including the arcuate wall 20 and bottom surface 22. The second fibrous material 18 is selected from the above listed suitable materials other than coconut fiber.

Preferably, the second fibrous material 18 is moss as moss complements the coconut fiber layer 12. Further, moss can be easily deposited and adhered onto the coconut fiber layer 12 in individual portions where necessary.

The second fibrous material 18 may be adhered onto the coconut fiber layer 12 using any suitable adhesive such as, for example, a spray adhesive, an epoxy, a polyurethane, or the like. The adhesive is applied either directly onto the exterior surface 16 or be admixed with the second fibrous material 18 prior to application.

In either instance, the second fibrous material 18 is adhered onto the coconut fiber layer 12 by either manually wrapping the second fibrous material 18 around the exterior surface 16, if it is in the form of a sheet, or by placing individual amounts of the second fibrous material 18 thereonto.

Once the second fibrous material 18 is sufficiently adhered onto the coconut fiber layer 12, the second fibrous material 18 forms a second fibrous layer 26. This dual layer of fibrous materials, i.e. the coconut fiber layer 12 and the second fibrous layer 26, improves the water absorbing capacity of the liner 10 while still allowing sufficient airflow to pass therethrough.

The present invention may be used as either a standalone product or, alternatively, in connection with a container to provide additional structural integrity to the liner 10.

In use as a standalone product, the liner 10 may be situated on a table or other surface, or planted in the ground. Here, it is preferred that the bottom surface 22 of the coconut fiber layer 12 be substantially flat or planar so that the liner 10 can be placed on a flat surface without falling over. Furthermore, it is essential that the liner 10 be rendered rigid by being sprayed with an adhesive in order to better maintain its shape.

Where a container is employed, either the liner 10 is specifically formed to fit within the container or, alternatively, a container may be selected which provides an interior of sufficient size to enable the liner 10 to be emplaced therein.

Referring again to FIG. 1, the liner 10 is shown disposed within a container 28. The container 28 is, preferably, a wire-framed structure or basket for providing sufficient support to the liner 10 while also enabling visual inspection thereof. As shown, the container 28 includes a circular bottom rim 30 to support the bottom surface 22 of the liner 10. The container 28 further includes a plurality of legs 32 extending upwardly from the bottom rim 30 and terminating proximate the top edge 24 of the coconut fiber layer 12. A top rim 34 is disposed opposite that of the bottom rim 30 and interconnects each one of the plurality of legs 32.

Where the container 28 is used for hanging purposes, the container 28 further includes a plurality of arms 36 extending upwardly from the top rim 34. Means 37 for hanging the container 28, such as a ring 38, magnet, or the like, is mounted to the ends of each one of the plurality of arms 36. The ring 38 is used to removably secure the container 28 to a hook or the like so that the container 28 may be hung therefrom. Preferably, the plurality of arms 36 converge at a single point above the top rim 34 to facilitate hanging the container 28 with a single ring 38.

It is to be understood that the container 28 need not include the wire-frame structure as described above. The container 28 may, alternatively, include a solid frame such as a bucket formed from a metal, plastic, or the like. Nonetheless, the wire-frame structure provides optimal support to the liner 10 while ensuring adequate airflow passes through.

It is to be understood that the container 28 does not form part of the present invention, but is described for illustrative purposes.

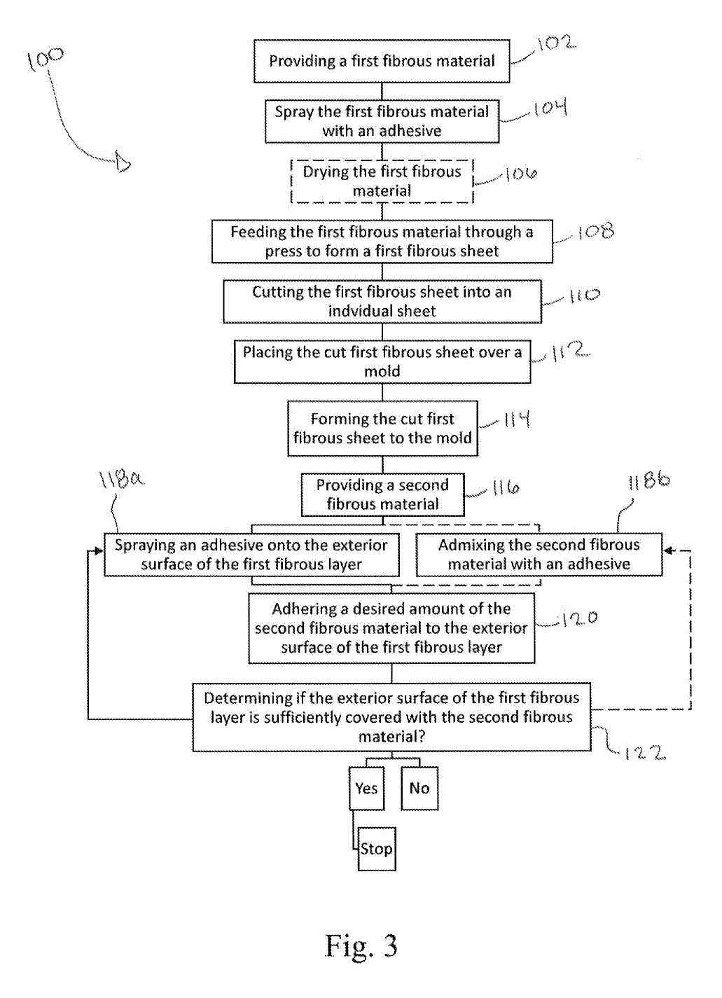

Now, and with reference to FIG. 3, there is depicted a block diagram showing a method denoted at 100 for manufacturing a dual layer planter liner in accordance herewith.

In describing the method 100, it is to be understood that the first and second fibrous materials used in accordance herewith are the same as that described in detail above.

The method 100, generally, comprises the steps of: (a) providing a first fibrous material at 102; (b) forming the first fibrous material into a molded first fibrous layer at 104-114, the first fibrous layer having an interior surface and an exterior surface; (c) providing a second fibrous material at 116; and (d) adhering the second fibrous material onto the exterior surface of the first fibrous layer at 120.

Generally, the coconut fiber liner is formed by, initially, providing a desired amount of coconut fiber at 102. The coconut fiber is then laid flat and each side of the coconut fiber is sprayed with either an adhesive or a latex at 104. Optionally, where the coconut fiber is sprayed with an adhesive and needs to be dried, the coconut fiber may be passed through a dryer at 106. The coconut fiber is placed within the dryer at a temperature of about 250° F. for about ten minutes. Preferably, heat is not applied to the coconut where it is sprayed with a latex. Once the coconut fiber is dry, it is fed through a rubber-coated roller, press, or other suitable sheet-making machine at 108. This forms the coconut fiber into a flattened coconut fiber sheet. The coconut fiber sheet is then cut into smaller individual coconut fiber sheets at 110. Depending on the size and thickness of the coconut fiber sheet, it may be cut using scissors, a band saw machine, or the like. A cut coconut fiber sheet is then placed over a mold at 112 and a mandrel ram or other suitable mechanical press applies a high degree of pressure at a temperature of about 250° F. for approximately 5 minutes at 114. This causes the cut coconut fiber sheet to conform to the shape of the mold and form a molded coconut fiber layer. Preferably, where the coconut fiber is previously sprayed with a latex, the mechanical press does not apply any heat to the coconut fiber sheet in conforming the sheet to the mold.

Thereafter, the second fibrous material is provided at 116 for coating the exterior surface of the molded coconut fiber layer. There are two preferred methods for adhering the second fibrous material onto the coconut fiber layer.

First, an adhesive may be sprayed onto the exterior surface of the coconut fiber layer at 118a. Then, the second fibrous material is placed onto the sprayed coconut fiber layer. This is the preferred method where the entire exterior surface of the coconut fiber layer is intended to be covered.

Alternatively, the second fibrous material may be admixed with an adhesive at 118b. Thereafter, the second fibrous material is physically deposited and adhered onto either the entire exterior surface of the coconut fiber layer or only at specified desired areas.

Regardless of the method of applying the adhesive, the second fibrous material is adhered to at least a substantial portion of the exterior surface of the coconut fiber layer at 120.

After adhering the second fibrous material, it may be determined whether the exterior surface of the coconut fiber layer is sufficiently covered a desired amount at 122. If it is desired that the exterior surface of the coconut fiber layer be additionally covered, then steps 118a or 118b, based on the method of adhering the second fibrous material, through 122 are repeated.

From the above, it is to be appreciated that defined herein is a new and unique planter liner, and method for making same, that retains an adequate amount of water without preventing airflow to plants disposed therein.

1. A dual layered planter liner comprising:
a first fibrous layer having an interior surface and an exterior surface, the first fibrous layer formed into a pot for emplacing a planting medium and/or plant therein, the first fibrous layer formed from a first fibrous material; and (b) a second fibrous material adhered onto the exterior surface of the first fibrous layer, the adhered second fibrous material forming a second fibrous layer.

2. The dual layered planter liner of claim 1, wherein:
the first fibrous material and second fibrous material are different.

3. The dual layered planter liner of claim 2, wherein:
the first fibrous material is selected from a group consisting of coconut fiber, sphagnum, Spanish moss, paper/pulp mache, sisal or similar grass, wood bark, foliage, wool and woven textiles.

4. The dual layered planter liner of claim 3, wherein:
the second fibrous material is selected from the group consisting of coconut fiber, sphagnum, Spanish moss, paper/pulp mache, sisal or similar grass, wood bark, foliage, wool and woven textiles; and
wherein the first and second fibrous materials are different from each other.

5. The dual layered planter liner of claim 4, wherein:
the first fibrous material is coconut fiber; and
the second fibrous material is moss.

6. The dual layered planter liner of claim 5, wherein:
the exterior of the first layer of coconut fiber is coated with an adhesive for facilitating adherence of the moss thereto.

7. The dual layered planter liner of claim 5, wherein the adhesive and moss are an admixture.

8. The dual layered planter liner of claim 1, wherein:
the liner has a substantially planar bottom and upstanding arcuate sidewall, the liner defining a planter.

9. A dual layered planter comprising;
a wire frame, and the dual layer planter liner of claim 5.

10. The planter of claim 9, wherein the planter is removably emplaced within the frame.

11. The planter of claim 9 further comprising:
a plurality of upwardly extending arms, extending upwardly from the frame, the arms defining means for suspending the planter above a surface.

12. A method for making a dual layered planter comprising the steps of:
(a) providing a first fibrous material;
(b) spraying each side of the first fibrous material with a minimal airflow restrictive adhesive or latex;
(c) drying the first fibrous material;
(d) feeding the first fibrous material through a roller to provide a first fibrous sheet;
(e) cutting the first fibrous sheet into predetermined sizes of smaller first fibrous sheets;
(f) placing one of the smaller first fibrous sheets over a mold;
(g) applying pressure to the smaller first fibrous sheet to provide a first fibrous layer conforming to the shape of the mold, the molded first fibrous layer having an interior surface and an exterior surface;
(h) providing a second fibrous material; and
(i) manually adhering the second fibrous material onto the exterior surface of the molded first fibrous layer, the adhered second fibrous material forming a second fibrous layer.

13. The planter of claim 12, wherein:
the first fibrous material is selected from a group consisting of coconut fiber, sphagnum, Spanish moss, paper/pulp mache, sisal or similar grass, wood bark, foliage, wool and woven textiles.

14. The method of claim 13 wherein:
the planter of claim 13, wherein:
the second fibrous material is a sheet, the sheet being wrapped around the exterior surface of the first fibrous layer, the second fibrous material is selected from the group consisting of coconut fiber, sphagnum, Spanish moss, paper/pulp mache, sisal or similar grass, wood bark, foliage, wool and woven textiles; and
wherein the first and second fibrous materials are different from each other.

15. The method of claim 13 wherein:
the second fibrous material and adhesive are admixed together prior to applying the second fibrous material to the exterior of the first fibrous material.
